(19) United States
(12) Patent Application Publication
(10) Pub. No.: US 2016/0201390 A1
(43) Pub. Date: Jul. 14, 2016

(54) Roller Blind for a Window that Affords Positioning of a Screen at a Stable Height by Means of a Frictional Interface

(71) Applicant: Les McGowan, Calgary (CA)

(72) Inventor: Les McGowan, Calgary (CA)

(21) Appl. No.: 14/932,449

(22) Filed: Nov. 4, 2015

(30) Foreign Application Priority Data
Jan. 9, 2015 (CA) 2877254

(51) Int. Cl. E06B 9/60; E06B 9/62

(52) U.S. Cl. CPC E06B 9/60; E06B 9/62

(57) ABSTRACT

A roller blind for a window features a fixed shaft and a one-way bearing received thereon which is arranged for rotational motion about the fixed shaft in only one rotational direction. A tube is received over the bearing and is arranged for rotational motion relative thereto. The roller blind also features a torsion spring received on the shaft, having longitudinally opposing spring ends respectively coupled to the tube and the fixed shaft. A screen is arranged to be wound about the tube in the rotational direction of the bearing. Furthermore, the screen has a free end with a weighted element coupled thereto. As such, the free end of the screen is positioned at a stable height by mechanism of a frictional interface between the tube and the bearing, a torsion force of the torsion spring, and a weight of the weighted element.

This application claims benefit under 35 U.S.C. 119(a) of Canadian Application Serial No. 2,877,254 filed Jan. 9, 2015.

### FIELD OF THE INVENTION

The present invention generally relates to a roller blind for a window, and more particularly the present invention relates to a roller blind which is arranged for accurate placement of a screen of the roller blind at a stable position of the screen without need for jerking movements.

### BACKGROUND

It is challenging to position a screen of a roller blind, which is used with a window, at a desired height along the window. Positioning the screen at the desired height often involves pulling same downward past the desired height, followed by applying a jerking motion to effect locking of the screen at the particular height. This method, which is necessitated by a locking mechanism of the roller blind to maintain the screen at the desired height, is inaccurate in attaining the desired height on a first attempt and has to be repeated several times before the desired height is achieved.

Canadian Patent Application 2,516,086 to McGowan describes a push-pull roller blind which allows a user to apply a gentle force to accurately position the screen of the push-pull roller blind at the desired height. The patent comprises a fixed shaft and inner and outer tubes, which are received over the fixed shaft in concentric relation thereto; a disc received on the fixed shaft coupled to the outer tube which is arranged for rotational motion about the fixed shaft; a torsion spring received over the fixed shaft coupled between the disc and the shaft; and a frictional interface between the inner and outer tubes.

While the patent application of McGowan achieves its desired purpose, same does so with a number of unnecessary parts that increases the complexity of the locking mechanism. Presence of the unnecessary parts may increase manufacturing costs. Furthermore, as parts of the push-pull roller blind wear out due to regular use, replacing components becomes proportionately more difficult as the number of components increases.

Applicant provides an improvement over his prior patent application in which the same type of functionality can be achieved with fewer parts.

### SUMMARY OF THE INVENTION

According to one aspect of the invention there is provided a roller blind for a window comprising:

a fixed shaft;

a tube received over the fixed shaft so as to be in concentric relation thereto, the tube having an outer surface, an inner surface, and opposing longitudinal ends and the tube being arranged for rotational motion relative to the fixed shaft about same;

a mounting portion at said opposing longitudinal ends of the tube for mounting adjacent to the window;

a torsion spring received on the fixed shaft between the fixed shaft and the tube, the torsion spring having longitudinally opposing spring ends and being arranged to provide a torsion force about an axis of the fixed shaft;

a screen which is arranged to be wound and unwound about the outer surface of the tube, the screen having a first longitudinal screen end coupled to the outer surface of the tube and a second longitudinal screen end which is opposite the first longitudinal end and is free;

a weighted element coupled to the second longitudinal screen end;

a bearing having an inner bearing portion which receives the fixed shaft therein and an outer bearing portion which is arranged for rotational motion relative to the inner bearing portion in only one rotational direction;

wherein a first one of the spring ends is coupled to the shaft and a second one of the spring ends is coupled to the inner surface of the tube;

wherein the inner surface of the tube is arranged for frictional but moveable contact relative to the outer bearing portion;

wherein the screen is arranged to be wound about the outer surface of the tube in the rotational direction of the outer bearing portion;

wherein the weighted element has a weight which is arranged to balance the torsion force of the torsion spring, when at least a portion of the screen is unwound from about the outer surface of the tube so as to extend downward from the tube at an unwound length, and a frictional force at the frictional interface so as to maintain the screen at said unwound length.

The embodiment as described in more detail hereinafter achieves the same type of functionality of the prior art, although with fewer parts which reduce a complexity of inner workings of the embodiment. Having fewer parts is advantageous simply because there are fewer parts that can become damaged, whether due to extraordinary causes or due to wear and tear from regular use. Furthermore, an arrangement of the torsion spring makes it easy to detach from the fixed shaft and inner surface of the tube, so that if either one of the torsion spring, rotational element, or tube needs to be replaced, the replacement can be done with substantial ease compared to the same type of part replacement in the prior art.

In one instance, the frictional but moveable contact is provided by direct, surface-to-surface contact between the inner surface of the tube and the outer rotatable portion.

In another instance, the frictional but moveable contact is provided by a resilient material disposed between the inner surface of the tube and the outer rotatable portion in a space therebetween.

Preferably, the rotational element is a bearing.

Preferably, the fixed shaft has a free end within the tube, the free end having a slot therein which is arranged to receive the first one of the spring ends therein.

According to one aspect of the invention there is provided a roller blind for a window comprising:

a fixed shaft;

a tube received over the fixed shaft so as to be in concentric relation thereto, the tube having an outer surface, an inner surface, and opposing longitudinal ends and the tube being arranged for rotational motion relative to the fixed shaft about same;

a mounting portion at said opposing longitudinal ends of the tube for mounting adjacent to the window;

a torsion spring received on the fixed shaft between the fixed shaft and the tube, the torsion spring having longitudinally opposing spring ends and being arranged to provide a torsion force about an axis of the fixed shaft;

a screen which is arranged to be wound and unwound about the outer surface of the tube, the screen having a first longitudinal screen end coupled to the outer surface of the tube and a second longitudinal screen end which is opposite the first longitudinal end and is free;

a weighted element coupled to the second longitudinal screen end;

a bearing having an inner bearing portion which receives the fixed shaft therein and an outer bearing portion which is arranged for rotational motion relative to the inner bearing portion in only one rotational direction;

a resilient material disposed between the inner surface of the tube and the outer bearing portion in a space therebetween, the resilient material being arranged to provide a frictional interface between the inner surface of the tube and the outer bearing portion;

wherein a first one of the spring ends is coupled to the shaft and a second one of the spring ends is coupled to the inner surface of the tube;

wherein the screen is arranged to be wound about the outer surface of the tube in the rotational direction of the outer bearing portion;

wherein the weighted element has a weight which is arranged to balance the torsion force of the torsion spring, when at least a portion of the screen is unwound from about the outer surface of the tube so as to extend downward from the tube at an unwound length, and a frictional force at the frictional interface so as to maintain the screen at said unwound length.

### BRIEF DESCRIPTION OF THE DRAWINGS

One embodiment of the invention will now be described in conjunction with the accompanying drawings in which:

FIG. 1 is a schematic view of the roller blind with a cutaway of the tube and cross-section of the bearing.

FIG. 2 is a perspective view of the roller blind in FIG. 1 with the screen wound about the tube.

FIG. 3 is an end view of the roller blind in FIG. 1 at the end thereof having the bearing.

In the drawings like characters of reference indicate corresponding parts in the different figures.

### DETAILED DESCRIPTION

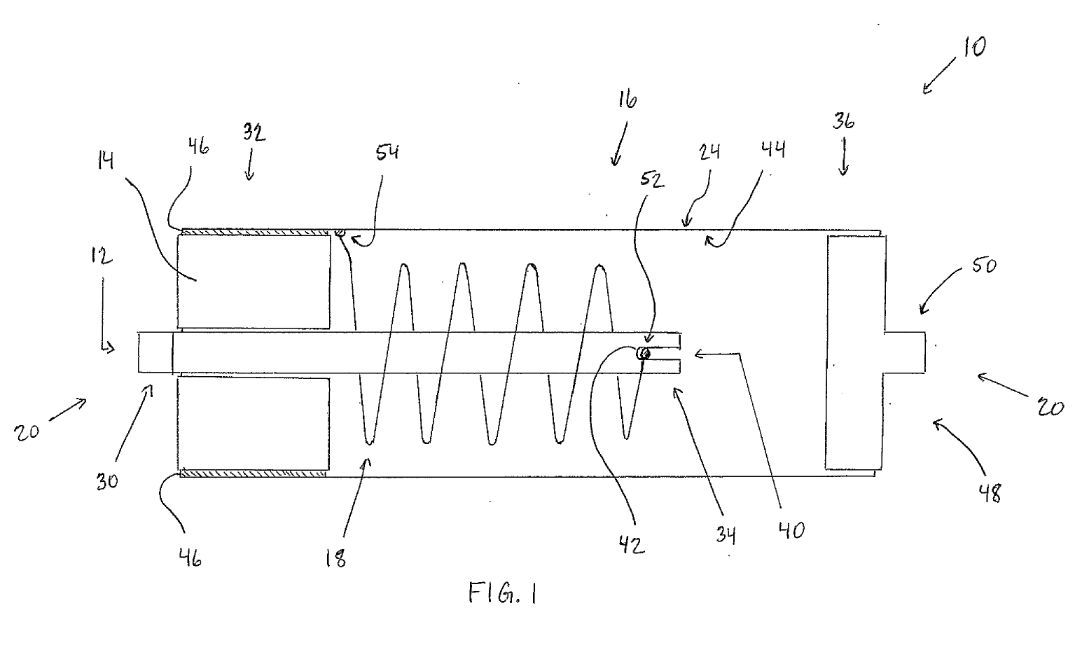

Referring to the accompanying drawings, there is a roller blind for a window that is generally indicated by reference numeral 10 in FIG. 1. The roller blind affords varying levels of privacy to occupants in a room by blocking portions of the window.

The roller blind illustrated in FIGS. 1-3 generally comprises a fixed shaft 12 and a one-way bearing 14, which has an inner stationary portion that receives the fixed shaft therein and an outer rotatable portion that is arranged for rotational motion relative to the inner stationary portion in only one rotational direction as known to a person skilled in the art. A tube 16 is received over the fixed shaft and the bearing so as to be in concentric relation to both. The roller blind further comprises a torsion spring 18 received on the fixed shaft between same and the tube in a radial direction, and the torsion spring is arranged to provide a torsion force about an axis of the shaft. The torsion force acting in the rotational direction of the outer rotatable potion of the bearing so as to effect untwisting of the spring is termed internal torsion force hereinafter for the purposes of this description. Furthermore, the roller blind has a mounting portion 20 at opposing longitudinal ends of the tube for mounting adjacent to the window. The roller blind also has a screen 22 which is arranged to be wound and unwound about an outer surface 24 of the tube. The screen has a first longitudinal screen end which is coupled to the outer surface of the tube in any suitable way known to a person skilled in the art, and a second longitudinal screen end 26 which is opposite the first longitudinal screen end and is free. A weighted element 28 is coupled to the screen at the second longitudinal screen end thereof.

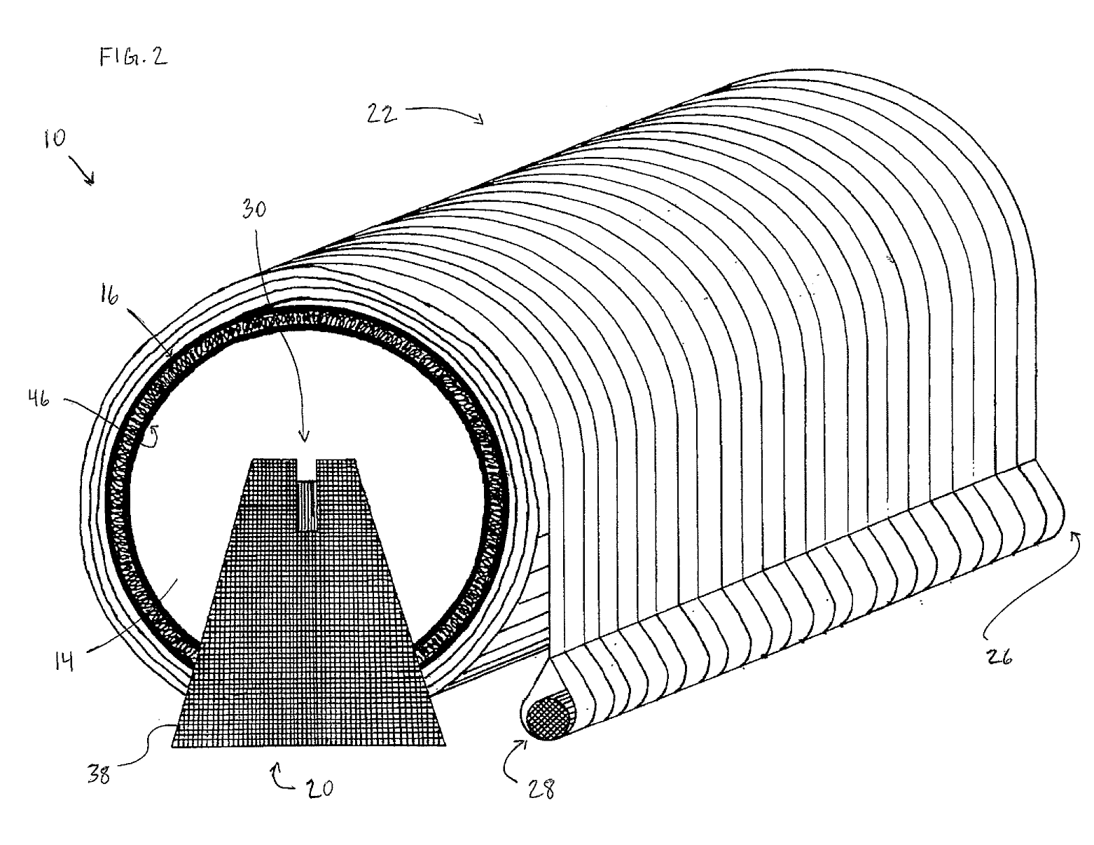

Turning now to the fixed shaft 12 in more detail with particular reference to FIG. 1, the fixed shaft is elongate and circularly cylindrical in shape. The fixed shaft is horizontally oriented and has opposing longitudinal ends: a fixed end 30 which extends past a first longitudinal end 32 of the tube 16, and a free end 34 which is within the tube. The fixed end of the shaft is a first portion of the mounting portion 20 of the roller blind 10 at the first longitudinal end of the tube. As such, the fixed end is shaped so as to have opposing flattened surfaces forming a rectangular cross-section. The opposing flattened surfaces of the fixed end are produced by grinding off portions of the fixed shaft so as to reduce the circular cross-section thereof to the rectangular cross-section of the fixed end. The fixed end is received in a receiving slot of a first mounting bracket 38, shown in FIG. 2, at one lateral side of the window that keeps the fixed shaft stationary. The first mounting bracket provides sufficient support to the fixed shaft to maintain the shaft in a horizontally oriented position thereof and reduce likelihood of pivotal motion of the shaft relative to the first mounting bracket about the fixed end. In contrast, the free end has a slot 40 therein so as to form two prongs, each of which are substantially semi-circular in cross section, at the free end. The slot is formed horizontally along a diameter of the shaft. The slot starts at an open end thereof and extends horizontally towards the fixed end of the shaft, terminating at a terminal end 42 thereof. The purpose of the fixed shaft is to define a central axis of the roller blind 10, and some of the other components of the roller blind are mounted to this central axis while other components rotate relative thereto.

Turning now to the bearing 14, the bearing is received on the fixed shaft 12 at a location thereon intermediate the opposing longitudinal ends of the fixed shaft, which is immediately adjacent to the fixed end 30 thereof as illustrated in FIG. 1. The purpose of the bearing is to provide a rotational element which is directional, i.e., that is intended to rotate in only one rotational direction, and causes the tube 16 to tend to rotate in the same rotational direction as the outer rotatable portion 18 of the bearing for reasons which will be highlighted later.

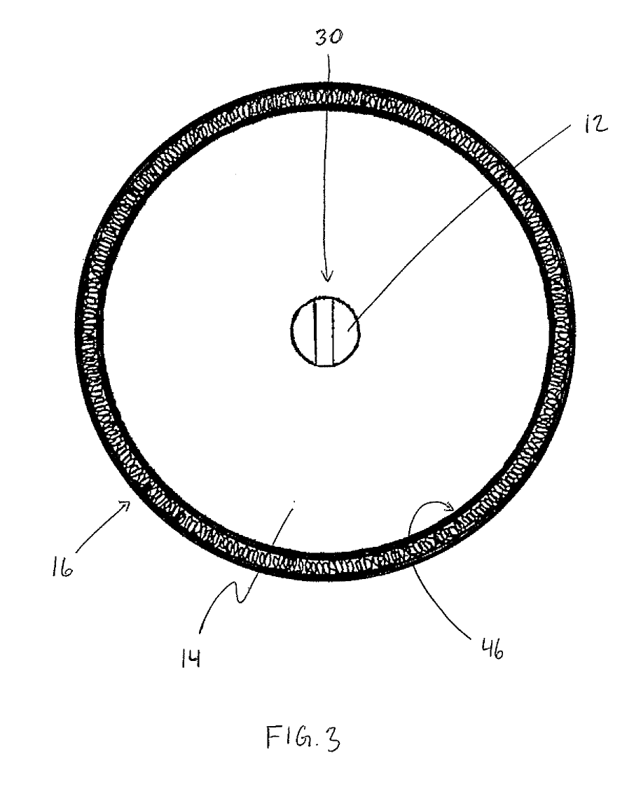

Next, the tube 16 is elongate and circular cylindrical in shape. The tube has an inner surface 44 in addition to the outer surface 24 of the tube and the first 32 and second 36 longitudinal ends thereof. Being received over the bearing 14, the tube is arranged for rotational motion relative to the fixed shaft 12 and relative to the outer rotatable portion of the bearing. More specifically, the tube rotates about the outer rotatable portion 18 of the bearing. As such, the tube is sized so that a tube diameter thereof matches or is slightly larger than an outer diameter of the bearing. Furthermore, the tube diameter is larger than the shaft diameter of the fixed shaft because the tube is received over both the fixed shaft and the bearing, which itself is received on the shaft. In addition, a frictional interface 46 illustrated in FIG. 3 is located between the outer rotatable portion of the bearing and a longitudinal portion of the inner surface of the tube that overlaps the outer rotatable portion thereabout as shown in FIG. 1. As shown in FIG. 3, the frictional interface 46 may optionally be a resilient material disposed in a space between the inner surface 44 of the tube and the outer rotatable portion 18, though the frictional interface could also be direct, surface-to-surface contact therebetween. In an embodiment in which the resilient material is used, same may be leather or a coating with a specific viscosity that affords rotational motion of the tube 16 relative to the outer rotatable portion of the bearing 14 thereabout, especially in the opposite rotational direction of the bearing. The resilient material is selected so that static and kinetic friction coefficients thereof are sufficient to afford the intended functionality of the roller blind 10.

Further to the frictional interface, a second portion of the mounting portion 20 is received in the second longitudinal end of the tube which is opposite the bearing. The second portion of the mounting portion comprises a circular cap 48 which fits into the tube and remains in fixed relation thereto, i.e., the cap and tube rotate in unison in both rotational directions. Generally, the cap has a thickness, which is measured between an inner cap surface facing the fixed shaft and an outer cap surface facing outwards away from any part of the roller blind, arranged so that the free end of the fixed shaft is spaced from the inner cap surface. The spacing therebetween prevents unintended frictional engagement between the inner cap surface and the free end. In addition, the cap has a round stub 50 protruding outwards from the outer surface of the cap at a center thereof, which is supported on a receiving slot of a second mounting bracket located at another lateral side of the window. The second mounting bracket is arranged to support the cap thereon for rotational motion relative to the second mounting bracket about the central axis of the roller blind defined by the shaft.

The screen 22 provides privacy when it is unwound from about the tube 16 so as to block a portion of the window. While the screen can take on a variety of different shapes depending on the size and shape of the window, the screen is rectangular as illustrated in FIG. 2. The first longitudinal screen end spans a longitudinal length of the tube and is coupled longitudinally thereto as well. The second longitudinal screen end 26 is hemmed across a lateral width of the screen so as to receive the weighted element 28 therein. The screen is arranged to be wound about the outer surface 24 of the tube in the rotational direction of the outer rotatable portion of the bearing 14.

As shown in FIG. 2, the weighted element 28 coupled to the screen 22 is an elongate, metal bar and is referred to as a weighted bar hereinafter. As such, the weighted bar lies laterally across the screen, spanning the lateral width thereof so that an entirety of the second longitudinal screen end 26 is weighted equally along the lateral width thereof. The weighted bar is selected to have a weight arranged to balance the internal torsion force of the torsion spring 18, when at least a portion of the screen is unwound from about the outer surface 24 of the tube 16 so as to extend downward from the tube at an unwound length, and the frictional force at the frictional interface 46 so as to maintain the screen at the unwound length.

Turning now to the torsion spring 18 and referring to FIG. 1, the torsion spring is received on the fixed shaft 12 at a location thereon intermediate the bearing 14 and the free end 34 of the fixed shaft. The torsion spring has longitudinally opposing spring ends. A first one 52 of the spring ends is coupled to the shaft so as to be received in the slot 40 therein at the free end of the shaft, and a second one 54 of the spring ends is coupled to the inner surface 44 of the tube 16 at a location thereon closer to the bearing than to the free end of the fixed shaft. In the preferred embodiment, the second one of the spring ends is coupled at a location immediately adjacent the bearing, as illustrated in FIG. 1, and in such a way that the second one of the spring ends may be decoupled from the inner surface of the tube so that the torsion spring can be replaced without a need to damage existing components of the roller blind in a process of disassembling same. For example, the second one of the spring ends may be slidably received in a slot structure coupled to the inner surface of the tube, which is formed by a pair of prongs oriented longitudinally along the tube 16 and spaced angularly about the inner surface 44 thereof to create a prong slot between the pair of prongs. Free ends of the pair of prongs would be radially spaced from the inner surface of the tube so as to be able to receive the second one of the spring ends in the prong slot. Returning to attachment locations of the spring ends, the attachment locations of the spring ends are generally longitudinally spaced at a distance at least larger than an overall length of the torsion spring 18 to maintain a helical shape thereof so that the spring can operate properly. The torsion force applied to the spring that effects winding thereof, termed applied torsion force hereinafter, arises from rotating the tube 16 relative to the fixed shaft 12 so as to unwind the screen 22, in the rotational direction opposite to that of the outer rotatable portion of the bearing so that the outer rotatable portion does not rotate as the screen is unwound.

In use, the screen 22 is initially wound about the outer surface 24 of the tube 16 substantially in its entirety. To unwind the screen, a user grabs the second longitudinal screen end 26 and applies a downward force to same so as to begin unwinding the screen. This applied downward force must be enough to overcome a static friction force at the frictional interface 46 that is acting against the weight of the weighted bar 28 and the applied downward force. When the applied downward force overcomes the static friction force, the tube begins to rotate in the direction against that of the outer rotatable portion of the bearing 14 so that the outer rotatable portion remains stationary as the tube rotates relative thereto, and the screen is unwound. As the screen is unwound, the torsion spring 18 starts to twist and gain potential energy from the applied torsion force thereon so as to build the internal torsion force that effects untwisting of the spring. When the screen has been unwound to the unwound length that is desired, the user stops the second longitudinal screen end 26 by removing the downward force to bring the screen to a standstill, and then the user releases same. At this stage, the weight of the weighted bar 28 and the static friction at the frictional interface 46 is sufficient to maintain the screen 22 at a stable unwound length.

To raise the screen and decrease the unwound length, the user applies a gentle, upward force to the screen at a location along a portion of the screen that has been unwound, which is enough to initiate untwisting of the torsion spring 18, causing the tube to rotate with the outer rotatable portion of the bearing. There may be some slip of the tube relative to the outer rotatable portion even when both are rotating in the same direction; however, rotation in unison is not necessary for proper operation of the roller blind. As such, the screen 22 winds about the outer surface 24 of the tube 16 as the tube rotates with the bearing and the torsion spring untwists itself. When the second longitudinal screen end 26 nears the unwound length that is presently desired, the user removes the upward force on the second screen end. Now, the same static equilibrium to maintain the stable unwound length is in effect. The screen can be lowered or raised accurately to any desired height as described.

Further to the operation of the roller blind 10, a structure of the roller blind affords disassembly of the blind and replacement of the parts thereof. A shape of the first 38 and second mounting brackets allows the roller blind to be slidably removed from the receiving slots of the mounting brackets. In addition, sizing components such as the circular cap 48 to fit tightly into the tube 16 affords removal of the cap because it is not permanently coupled to the tube. When the roller blind is slidably removed from the mounting brackets, the process of disassembling the blind starts with pulling the circular cap longitudinally outwards from within the tube so as to access the free end 34 of the fixed shaft 12. Then, the first one 52 of the spring ends of the torsion spring 18 is removed from the slot 40 in the free end, decoupling the torsion spring from the shaft. Next, the tube is pulled in a longitudinal direction away from the fixed end 30 of the shaft so as to be slidably removed from over the bearing 14. At this stage, the second one 54 of the spring ends is accessible and consequently removed from the slot structure in which the second spring end is received, so as to fully decouple the torsion spring from any part of the roller blind and replace the torsion spring as needed. Next, the bearing is slidably removed from the fixed shaft 12 by pulling it towards one of the opposing longitudinal ends of the shaft over which the inner stationary portion fits so as to remove the bearing and replace same as needed. In the aforementioned manner, the roller blind can be disassembled for replacing any one of the parts thereof and easily reassembled by reversing the disassembly process.

While the preferred embodiment of the roller blind comprises parts that may be disassembled, it is important to realize that the parts of the roller blind may be permanently coupled to one another in other embodiments of the roller blind.

Since various modifications can be made in my invention as herein above described, and many apparently widely different embodiments of same made, it is intended that all matter contained in the accompanying specification shall be interpreted as illustrative only and not in a limiting sense.

1. A roller blind for a window comprising:
a fixed shaft;
a tube received over the fixed shaft so as to be in concentric relation thereto, the tube having an outer surface, an inner surface, and opposing longitudinal ends and the tube being arranged for rotational motion relative to the fixed shaft about same;
a mounting portion at said opposing longitudinal ends of the tube for mounting adjacent to the window;
a torsion spring received on the fixed shaft between the fixed shaft and the tube, the torsion spring having longitudinally opposing spring ends and being arranged to provide a torsion force about an axis of the fixed shaft;
a screen which is arranged to be wound and unwound about the outer surface of the tube, the screen having a first longitudinal screen end coupled to the outer surface of the tube and a second longitudinal screen end which is opposite the first longitudinal end and is free;
a weighted element coupled to the second longitudinal screen end;
a bearing having an inner bearing portion which receives the fixed shaft therein and an outer bearing portion which is arranged for rotational motion relative to the inner bearing portion in only one rotational direction;
wherein a first one of the spring ends is coupled to the shaft and a second one of the spring ends is coupled to the inner surface of the tube;
wherein the inner surface of the tube is arranged for frictional but moveable contact relative to the outer bearing portion;
wherein the screen is arranged to be wound about the outer surface of the tube in the rotational direction of the outer bearing portion;
wherein the weighted element has a weight which is arranged to balance the torsion force of the torsion spring, when at least a portion of the screen is unwound from about the outer surface of the tube so as to extend downward from the tube at an unwound length, and a frictional force at the frictional interface so as to maintain the screen at said unwound length.

2. The roller blind according to claim 1, wherein the frictional but moveable contact is provided by direct, surface-to-surface contact between the inner surface of the tube and the outer rotatable portion.

3. The roller blind according to claim 1, wherein the frictional but moveable contact is provided by a resilient material disposed between the inner surface of the tube and the outer rotatable portion in a space therebetween.

4. The roller blind according to claim 1, wherein the rotational element is a bearing.

5. The roller blind according to claim 1, wherein the fixed shaft has a free end within the tube, the free end having a slot therein which is arranged to receive the first one of the spring ends therein.

6. A roller blind for a window comprising:
a fixed shaft;
a tube received over the fixed shaft so as to be in concentric relation thereto, the tube having an outer surface, an inner surface, and opposing longitudinal ends and the tube being arranged for rotational motion relative to the fixed shaft about same;
a mounting portion at said opposing longitudinal ends of the tube for mounting adjacent to the window;
a torsion spring received on the fixed shaft between the fixed shaft and the tube, the torsion spring having longitudinally opposing spring ends and being arranged to provide a torsion force about an axis of the fixed shaft;
a screen which is arranged to be wound and unwound about the outer surface of the tube, the screen having a first longitudinal screen end coupled to the outer surface of the tube and a second longitudinal screen end which is opposite the first longitudinal end and is free;
a weighted element coupled to the second longitudinal screen end;
a bearing having an inner bearing portion which receives the fixed shaft therein and an outer bearing portion which is arranged for rotational motion relative to the inner bearing portion in only one rotational direction;
a resilient material disposed between the inner surface of the tube and the outer bearing portion in a space therebetween, the resilient material being arranged to provide a frictional interface between the inner surface of the tube and the outer bearing portion;
wherein a first one of the spring ends is coupled to the shaft and a second one of the spring ends is coupled to the inner surface of the tube;
wherein the screen is arranged to be wound about the outer surface of the tube in the rotational direction of the outer bearing portion;
wherein the weighted element has a weight which is arranged to balance the torsion force of the torsion spring, when at least a portion of the screen is unwound from about the outer surface of the tube so as to extend downward from the tube at an unwound length, and a frictional force at the frictional interface so as to maintain the screen at said unwound length.
